(19) United States
(12) Patent Application Publication
(10) Pub. No.: US 2013/0329932 A1
(43) Pub. Date: Dec. 12, 2013

(54) SOUND COLLECTOR AND ELECTRONIC APPARATUS HAVING SOUND COLLECTOR

(71) Applicant: KABUSHIKI KAISHA TOSHIBA, (US)

(72) Inventors: Takashi Sudo, Fuchu-shi (JP); Osamu Nishimura, Kawasaki-shi (JP); Akihiko Enamito, Kawasaki-shi (JP); Takahiro Hiruma, Tokyo (JP); Takafumi Ninomiya, Nishitama-gun (JP); Masaru Sakai, Hakui-shi (JP); Akinori Kawamura, Kunitachi-shi (JP); Kazushige Ouchi, Saitama-shi (JP)

(73) Assignee: KABUSHIKI KAISHA TOSHIBA, Tokyo (JP)

(21) Appl. No.: 13/680,917

(22) Filed: Nov. 19, 2012

(30) Foreign Application Priority Data
Nov. 22, 2011 (JP) 2011-254910

(51) Int. Cl. H04R 1/02

(52) U.S. Cl. CPC H04R 1/02
USPC 381/361

(57) ABSTRACT

According to one embodiment, a sound collector includes a housing and a microphone holding member. The housing includes an opening portion. The opening portion is configured to receive a sound wave having a path. The housing is configured to be tightly closed except the opening portion. The microphone holding member is configured to be provided in the housing and hold a microphone that receives the sound wave propagating through the path at a predetermined position.

### CROSS-REFERENCE TO RELATED APPLICATIONS

This application is based upon and claims the benefit of priority from prior Japanese Patent Application No. 2011-254910, filed Nov. 22, 2011, the entire contents of which are incorporated herein by reference.

### FIELD

Embodiments described herein relate generally to a sound collector and an electronic apparatus having the sound collector.

### BACKGROUND

Conventionally, a cellular phone, a portable information terminal, or the like includes a microphone for inputting voice. In recent years, some personal computers, TV receiver sets (to be sometimes referred to as a TV set hereinafter), and the like can also be equipped with a microphone for bidirectional voice communication.

For a cellular phone and the like, various kinds of contrivances or proposals have been made to improve sound collection to guide a voice to a microphone or prevent howling because of the structural limitations. On the other hand, in a TV set and the like, as the display panel to reproduce a video has become thinner, the main body, and in particular, a frame called a bezel that holds the display panel is also becoming thinner (bezel narrowing). The TV set includes a loudspeaker for outputting a reproduced sound. The loudspeaker has higher power as compared to that of a cellular phone or the like. For this reason, when a microphone is attached to the TV set, the influence on howling is large.

An electronic apparatus such as a flat-screen TV set has only a limited space to physically arrange a microphone. In addition, the neighborhood of the loudspeaker is not appropriate as the place to arrange the microphone. Hence, in an electronic apparatus such as a flat-screen TV set, it is difficult to arrange a microphone in a space with a large sound collection effect and stably guide a voice to the microphone.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIGS. 1A and 1B are views showing the outer appearance of an electronic apparatus having a sound collector according to the first embodiment;

FIG. 2 is a view showing a detailed arrangement of the sound collector according to the first embodiment;

FIG. 3 is a front view of a sound collector according to the second embodiment;

FIG. 4A is a side view of the sound collector according to the second embodiment;

FIG. 4B is a view showing the outer appearance of the sound collector according to the second embodiment;

FIG. 5 is a view for explaining the arrangement of a sound collector according to the third embodiment;

FIG. 6 is a view for explaining the arrangement of a sound collector according to the fourth embodiment;

FIGS. 7A and 7B are views showing examples of the microphones of the sound collectors according to the first to fourth embodiments;

FIG. 8 is a view for explaining the arrangement of a sound collector according to the fifth embodiment;

FIG. 9 is a view for explaining the arrangement of a sound collector according to the sixth embodiment;

FIG. 10 is a view for explaining the arrangement of a sound collector according to the seventh embodiment;

FIGS. 11A and 11B are views showing the outer appearance of an electronic apparatus according to the eighth embodiment;

FIG. 12 is a view showing a side surface of a sound collector according to the eighth embodiment; and

FIG. 13 is a view showing a side surface of a sound collector according to the ninth embodiment.

### DETAILED DESCRIPTION

Various embodiments will be described hereinafter with reference to the accompanying drawings.

In general, according to one embodiment, a sound collector includes a housing and a microphone holding member. The housing includes an opening portion. The opening portion is configured to receive a sound wave having a path. The housing is configured to be tightly closed except the opening portion. The microphone holding member is configured to be provided in the housing and hold a microphone that receives the sound wave propagating through the path at a predetermined position.

### First Embodiment

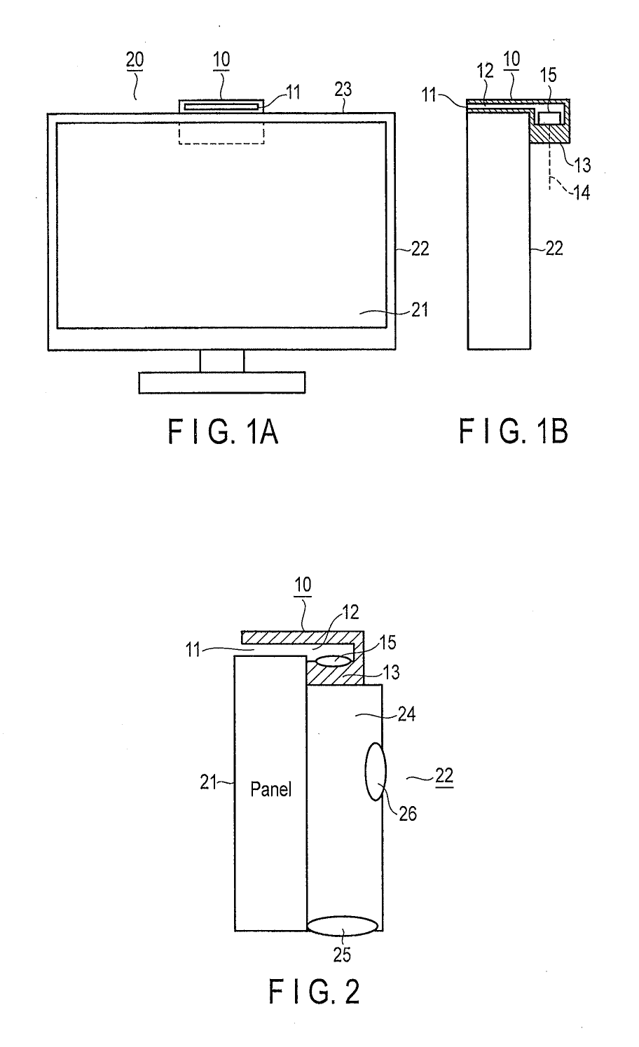

FIGS. 1A and 1B are views showing the outer appearance of an electronic apparatus 20 to which a sound collector 10 according to this embodiment is attached. FIG. 1A is a front view, and FIG. 1B is a side view.

As shown in FIG. 1A, the electronic apparatus 20 will specifically be exemplified as a TV receiver set (TV set). The TV set 20 includes a main body 22 including a display panel 21 formed from a liquid crystal panel, and a frame (to be referred to as a bezel hereinafter) 23 that holds the display panel 21. The display panel 21 serves as a screen to reproduce a video received by a video receiving module included in the main body 22.

The sound collector 10 according to this embodiment is attached on the upper side of the bezel 23. The sound collector 10 has, as its main body, a housing (case) that is tightly closed except an opening portion 11. The opening portion 11 has a slit shape and is designed to, for example, face the front surface side of the TV set 20 when the housing is attached on the upper side of the bezel 23.

As shown in FIG. 1B, a path 12 of a voice introduced from the opening portion 11 and a microphone holding member 13 that holds a microphone 15 are provided inside (hollow portion) the tightly closed housing of the sound collector 10. A signal line 14 of the microphone 15 is extended outside the housing and connected to, for example, a voice processing module included in the main body 22 of the TV set 20 and having a voice recognition function and the like.

FIG. 2 is a view showing details of the side view of FIG. 1B.

As shown in FIG. 2, the main body 22 of the TV set 20 includes the display panel 21, a board 24 formed from a plurality of layers, a loudspeaker 25, and a woofer 26. The video receiving module, the voice processing module, and the like are mounted on the board 24.

In the sound collector 10, the microphone holding member 13 is arranged on the rear surface side of the display panel 21 (in the direction of the depth of the main body 22) while the opening portion 11 is arranged on the front surface side of the TV set 20. The microphone holding member 13 holds the microphone 15 such that the nondirectional microphone 15 is arranged on the same plane as that of the voice path 12, that is, in parallel to the depth direction. The length of the path 12, that is, the distance from the opening portion 11 to the microphone 15 is, for example, about 3 cm. The distance is designed based on acoustic characteristics such as the quality of a sound to be input to the microphone 15.

In the sound collector 10 of this embodiment, for example, the voice of the user who is viewing a video reproduced on the display panel 21 is introduced from the opening portion 11 of the housing. As shown in FIG. 2, the voice (sound wave) introduced from the opening portion 11 propagates through the path 12 provided in the housing and is input to the microphone 15 held by the microphone holding member 13. The voice of the user is converted into a voice signal by the microphone 15 and sent to the voice processing module and the like included in the main body 22 of the TV set 20.

The sound collector 10 according to this embodiment can cut off sounds (containing noise) from around the TV set 20 except the side of the display panel 21 to some extent because the housing is tightly closed except the opening portion 11. The microphone 15 is arranged inside the housing on the back side of the display panel 21. For this reason, the microphone 15 can suppress input of sounds other than the voice from the opening portion 11.

In addition, since the TV set 20 includes the loudspeaker 25 and the woofer 26, sounds generated by them cause howling with the voice input to the microphone 15 at a high probability. The sound collector 10 according to this embodiment is arranged on the upper side of the display panel 21 and can therefore ensure the distance from the loudspeaker 25 and the woofer 26. In general, a sound has a characteristic of attenuating in proportion to the square of the distance.

When the opening portion 11 of the sound collector 10 is directed not in the direction of the sound source such as the loudspeaker 25 or the woofer 26 but to the front surface side of the TV set 20, the influence of echoes from the sound sources can be suppressed. That is, the sound collector 10 can collect sounds at a high acoustic characteristic (signal-to-echo ratio [SER]) even if there are sound sources such as the loudspeaker 25 and the woofer 26.

Hence, the sound collector 10 according to this embodiment can implement an effective sound collection function and stable voice input to the microphone 15. Especially, for the TV set 20 that implements the thinner bezel 23 (narrower bezel) as the main body 22 becomes thinner, it is difficult to mount the microphone 15 inside the bezel 23. In the sound collector 10 of this embodiment, the microphone 15 can be attached to the bezel 23 as a kind of detachable adapter without being incorporated in the bezel 23.

In the mainstream design of the flat-screen TV set 20, the loudspeaker 25 and the like are arranged at the lower portion of the display panel 21 with priority on the appearance. Since the influence of a reproduced sound from the loudspeaker 25 is large, and howling occurs, arranging the microphone 15 at the lower portion of the display panel 21 is not preferable from the viewpoint of the acoustic characteristics. In addition, the lower side of the main body 22 is not preferable as the place to arrange the microphone 15 because the sound collection effect deteriorates due to obstacles. The sound collector 10 according to this embodiment can ensure the space to arrange the microphone 15 with an excellent sound collection effect even in the flat-screen TV set 20 having only a limited space to mount the microphone 15.

### Second Embodiment

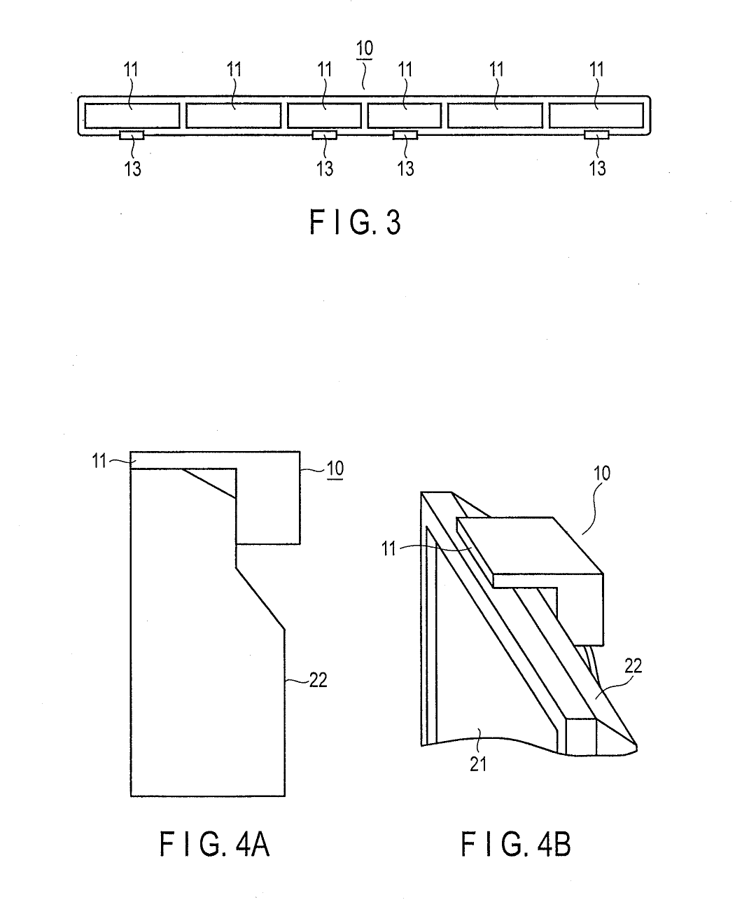

FIG. 3 is a front view showing the arrangement of a sound collector 10 according to the second embodiment. FIG. 4A is a side view. FIG. 4B is a view showing the outer appearance of the sound collector 10. Note that the internal structure of the sound collector 10 is the same as that shown in FIG. 2, and a description thereof will be omitted.

The sound collector 10 of this embodiment has a structure to incorporate a plurality of microphones. As shown in FIG. 3, the housing of the sound collector 10 according to this embodiment has such a structure that horizontally connects a plurality of sub-housings each having an opening portion 11. Each sub-housing has a tightly closed hollow portion and includes the opening portion 11, a path 12, and a microphone holding member 13, as shown in FIG. 2. One microphone is mounted on each microphone holding member 13.

FIG. 4A is a side view showing an arrangement in which the sound collector 10 of this embodiment is attached on the upper side of a display panel 21 of a TV set 20. A main body 22 of the TV set 20 includes the display panel 21 on the front surface side and a board 24 on the back side, as described above. FIG. 4B is a view showing the outer appearance of the sound collector 10 attached to the main body 22 of the TV set 20.

The sound collector 10 incorporating a plurality of microphones can also implement an effective sound collection function and stable voice input to a plurality of microphones 15. In addition, the sound collector 10 can be attached to a bezel 23 of the flat-screen TV set 20 as a kind of detachable adapter without incorporating the microphone 15 in the bezel 23.

### Third Embodiment

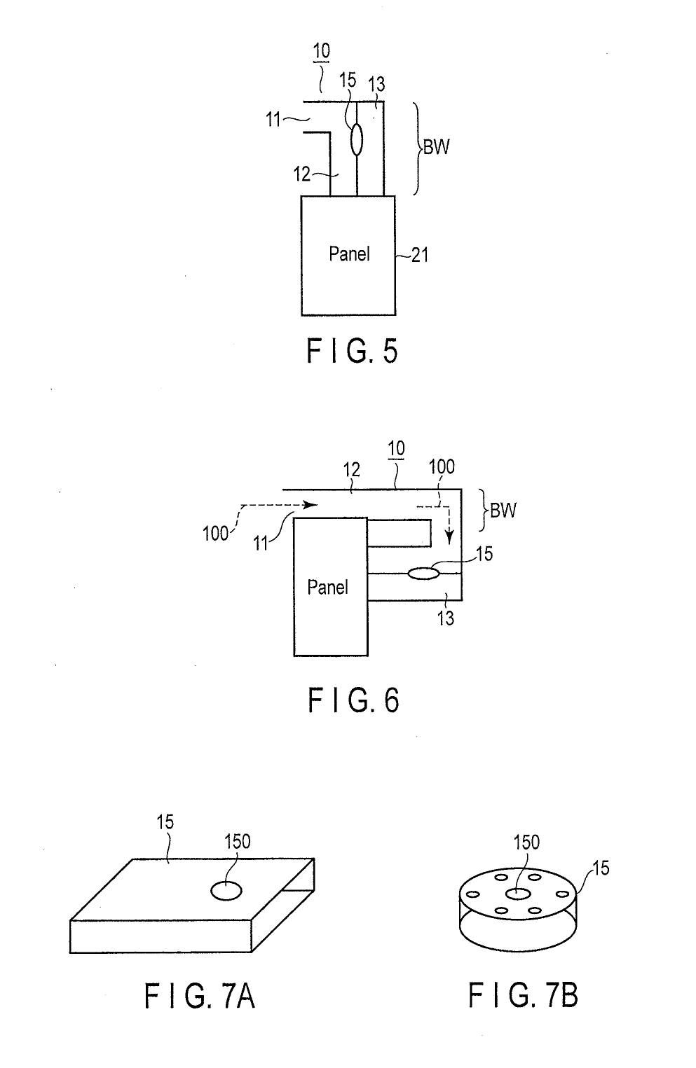

FIG. 5 is a side view showing the arrangement of a sound collector 10 according to the third embodiment. Note that the peripheral arrangement of a TV set 20 is the same as that shown in FIGS. 1A, 1B, and 2, and a description thereof will be omitted.

As shown in FIG. 5, in the sound collector 10 of this embodiment, a microphone holding member 13 is arranged not on the back side of a display panel 21 but on the upper side of the display panel 21. The housing has an L-shaped path 12 that continues from a slit-shaped opening portion 11. The microphone holding member 13 holds a microphone 15 so as to arrange it in the vertical direction with respect to the opening portion 11 arranged on the front surface side of the TV set 20.

In the sound collector 10 according to this embodiment, voice (sound wave) introduced from the opening portion 11 propagates through the path 12 in the horizontal direction and then the path 12 in the vertical direction and is input to the microphone 15 held by the microphone holding member 13. The voice of the user is converted into a voice signal by the microphone 15 and sent to the voice processing module and the like in the TV set 20.

The sound collector 10 according to this embodiment can also cut off sounds (containing noise) from around the TV set 20 to some extent because the housing is tightly closed except the opening portion 11, as described above. In addition, the sound collector 10 is arranged on the upper side of the display panel 21 and can therefore ensure the distance from a loudspeaker 25 and a woofer 26 of the TV set 20.

When the opening portion 11 is directed not in the direction of the sound source such as the loudspeaker 25 or the woofer 26 but to the front surface side of the TV set 20, the influence of echoes from the sound sources can be suppressed. Hence, the sound collector 10 according to this embodiment can implement an effective sound collection function and stable voice input to the microphone 15.

### Fourth Embodiment

FIG. 6 is a side view showing the arrangement of a sound collector 10 according to the fourth embodiment. Note that the peripheral arrangement of a TV set 20 is the same as that shown in FIGS. 1A, 1B, and 2, and a description thereof will be omitted.

As shown in FIG. 6, in the sound collector 10 of this embodiment, a microphone holding member 13 is arranged on the back side of a display panel 21 (in the direction of the depth of a main body 22) and on the lower side of the display panel 21 with respect to a slit-shaped opening portion 11. The housing has a path 12 that continues from the opening portion 11 in the horizontal and vertical directions and communicates with a hollow portion where the microphone holding member 13 is arranged. Note that the width of the opening portion 11 in the vertical direction corresponds to a width BW of a bezel 23 on the upper side of the display panel 21.

In the sound collector 10 according to this embodiment, voice (sound wave) 100 introduced from the opening portion 11 propagates through the path 12 in the horizontal direction and then through the path 12 in the vertical direction and is input to a microphone 15 held by the microphone holding member 13. The voice of the user is converted into a voice signal by the microphone 15 and sent to the voice processing module and the like in the TV set 20.

The sound collector 10 according to this embodiment can also cut off sounds (containing noise) from around the TV set 20 except on the side of the display panel 21 to some extent because the housing is tightly closed except the opening portion 11, as described above. In addition, since the microphone 15 is arranged on the lower side of the display panel 21 with respect to the opening portion 11, the influence of echoes from the sound sources such as a loudspeaker 25 and a woofer 26 can effectively be suppressed. Hence, the sound collector 10 according to this embodiment can implement an effective sound collection function and stable voice input to the microphone 15.

### Microphone Holding Member

FIGS. 7A and 7B are views showing examples of the microphones 15 of the sound collectors 10 according to the first to fourth embodiments.

FIG. 7A is a view showing the outer appearance of a micro-electromechanical system (MEMS) microphone. As shown in FIG. 7A, the microphone main body 15 is formed from a hollow rectangular parallelepiped having a size of, for example, 4 mm×3 mm×about 1 mm (height). A sound hole 150 is provided at part of the microphone main body 15.

FIG. 7B is a view showing the outer appearance of an electret condenser microphone (ECM). As shown in FIG. 7B, the microphone main body 15 is formed from a hollow cylinder. The sound hole 150 is provided at part of the surface.

### Fifth Embodiment

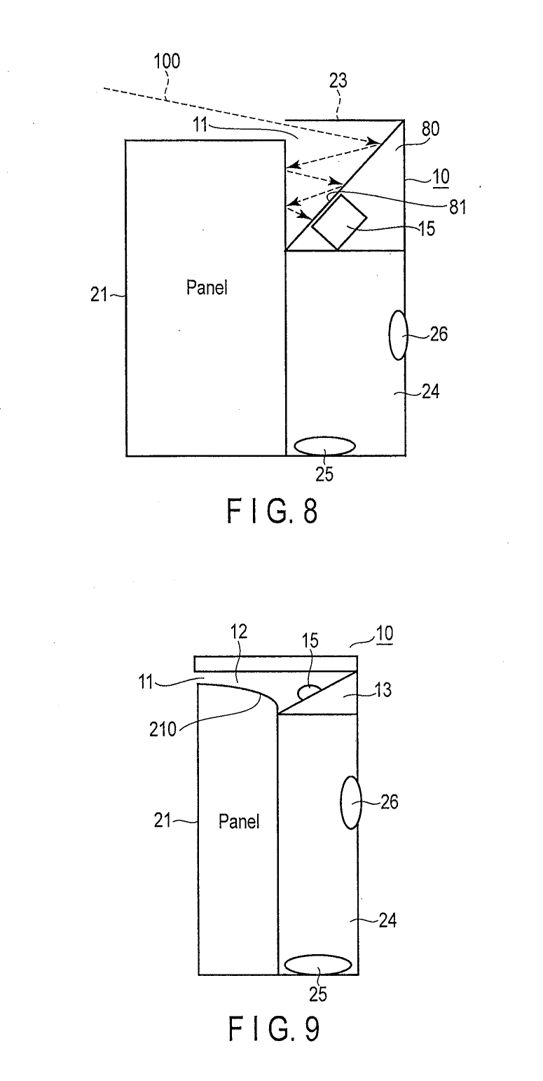

FIG. 8 is a side view showing the arrangement of a sound collector 10 according to the fifth embodiment. Note that the peripheral arrangement of a TV set 20 is the same as that shown in FIGS. 1A, 1B, and 2, and a description thereof will be omitted.

As shown in FIG. 8, in the sound collector 10 of this embodiment, the member to hold a microphone 15 is formed from an enclosure 80 having a surface inclined at a predetermined angle. The enclosure 80 is formed from a plastic member made of, for example, acrylic resin and has an opening portion 81 at a part where the microphone 15 is arranged. The sound collector 10 of this embodiment is arranged on the back side of a display panel 21. The TV set 20 of this embodiment has no bezel 23 on the upper side of the display panel 21.

In the sound collector 10 according to this embodiment, the voice (sound wave) 100 of the user on the front surface side of the display panel 21 is reflected between the inclined surface of the enclosure 80 and the back surface of the display panel 21 and input to the microphone 15 held by the enclosure 80, as shown in FIG. 8. The voice of the user is converted into a voice signal by the microphone 15 and sent to the voice processing module and the like in the TV set 20.

In the sound collector 10 according to this embodiment, the voice 100 propagating from the front surface side of the display panel 21 is input to the microphone 15 while being reflected between the inclined surface of the enclosure 80 and the back surface of the display panel 21. For this reason, the voice 100 is amplified by reflection and then input to the microphone 15. Hence, the sound collector 10 can collect the voice on the front surface side of the display panel 21 at a high signal characteristic (signal-to-noise ratio [SNR]).

On the other hand, the microphone 15 is covered with the enclosure 80 so that the voice is input from the opening portion 81 on the back surface side of the display panel 21. This allows to suppress the influence of echoes from the sound sources such as a loudspeaker 25 and a woofer 26 of the TV set 20. Hence, the sound collector 10 according to this embodiment can implement an effective sound collection function and stable voice input to the microphone 15.

### Sixth Embodiment

FIG. 9 is a side view showing the arrangement of a sound collector 10 according to the sixth embodiment. Note that the peripheral arrangement of a TV set 20 is the same as that shown in FIGS. 1A, 1B, and 2, and a description thereof will be omitted.

As shown in FIG. 9, the sound collector 10 of this embodiment is equivalent to the sound collector 10 of the first embodiment as shown in FIG. 2 in which the upper surfaces of a microphone holding member 13 and a display panel 21 have predetermined angles. That is, a microphone 15 held by the microphone holding member 13 is arranged upward at a predetermined angle. The display panel 21 has, as its upper surface, an inclined surface 210 that tilts at a predetermined angle from an opening portion 11 in the direction of the depth of a main body 22.

In the sound collector 10 according to this embodiment, voice (sound wave) introduced from the opening portion 11 propagates through a path 12 in the horizontal direction and is input to the microphone 15 held by the microphone holding member 13. In this case, the voice readily propagates because the inclined surface 210 of the display panel 21 tilts in the direction of the depth. In addition, since the microphone 15 is arranged upward at a predetermined angle, the voice introduced from the opening portion 11 can easily be input. Hence, the sound collector 10 can easily collect the voice on the front surface side of the display panel 21.

On the other hand, since the opening portion 11 of the sound collector 10 is directed to the front surface side of the display panel 21, the influence of echoes from the sound sources such as a loudspeaker 25 and a woofer 26 can be suppressed. That is, the sound collector 10 can effectively collect the voice of the user on the front surface side of the display panel 21 even if there are sound sources such as the loudspeaker 25 and the woofer 26.

### Seventh Embodiment

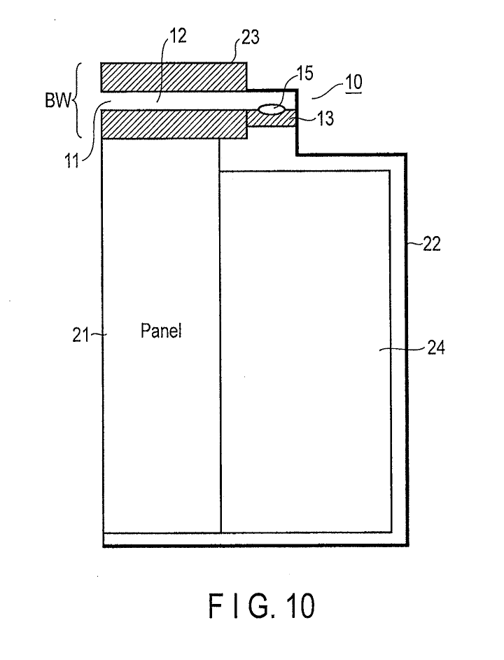

FIG. 10 is a side view showing the arrangement of a sound collector 10 according to the seventh embodiment. Note that the peripheral arrangement of a TV set 20 is the same as that shown in FIGS. 1A, 1B, and 2, and a description thereof will be omitted.

As shown in FIG. 10, the sound collector 10 according to this embodiment is formed from a housing (case) attached to be connected to an opening portion 11 and a voice path 12, which are formed in the upper portion of a bezel 23 having a width BW. The housing is tightly closed except the portion connected to the path 12 and includes a microphone holding member 13 that holds a microphone 15.

In the sound collector 10 of this embodiment, for example, the voice of the user who is viewing a video reproduced on a display panel 21 enters the housing via the opening portion 11 and the path 12 formed in the bezel 23. The voice that has propagated to the housing is input to the microphone 15 held by the microphone holding member 13. The voice of the user is converted into a voice signal by the microphone 15 and sent to the voice processing module and the like on a board 24 included in a main body 22 of the TV set 20.

The sound collector 10 according to this embodiment can also cut off sounds (containing noise) from around the TV set 20 and effectively suppress the influence of echoes from the sound sources such as a loudspeaker 25 and a woofer 26 because the housing is tightly closed except the opening portion 11 formed in the bezel 23, as described above. Hence, the sound collector 10 according to this embodiment can implement an effective sound collection function and stable voice input to the microphone 15.

Additionally, in this embodiment, since the opening portion 11 and the path 12 are formed in the bezel 23, the sound collector 10 can be attached as a kind of detachable adapter without incorporating the microphone 15 in the bezel 23. Hence, it is possible to make the bezel 23 thinner (narrower) and also arrange the sound collector 10 on the back surface side of the display panel 21. This allows to design the flat-screen TV set 20 with priority on the appearance.

### Eighth Embodiment

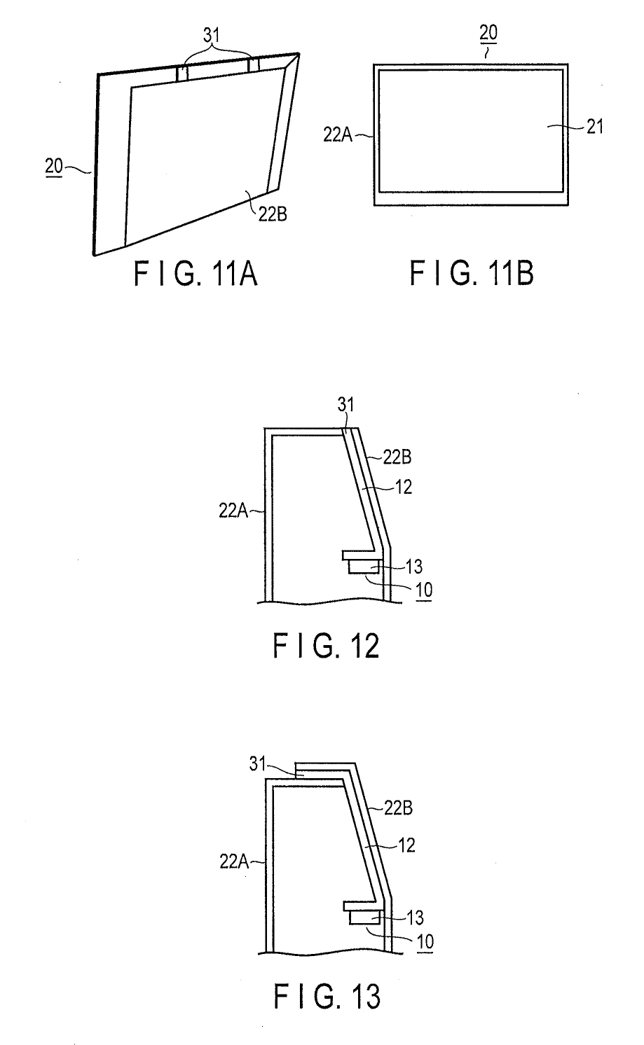

FIGS. 11A, 11B, and 12 are views showing the arrangement of a sound collector 10 according to the eighth embodiment. Note that the peripheral arrangement of a TV set 20 is the same as that shown in FIGS. 1A, 1B, and 2, and a description thereof will be omitted.

FIG. 11A is a view showing the outer appearance on the back surface side of the TV set 20. FIG. 11B is a view showing the outer appearance on the front surface side of the TV set 20. FIG. 12 is a side view showing the internal structure of the main body of the TV set 20.

As shown in FIG. 12, the sound collector 10 of this embodiment is detachably incorporated in the main body of the TV set 20 and includes a voice path 12 and a microphone holding member 13 that holds a microphone. The path 12 is arranged along a back cabinet 22B of the main body of the TV set 20. The path 12 continues to the hollow portion where the microphone holding member 13 is arranged.

The back cabinet 22B serves as the main body member that constructs the back surface side of the main body, as shown in FIG. 11A. In this embodiment, slits (opening portions) 31 are provided at, for example, two portions of the upper portion of the back cabinet 22B. As shown in FIG. 11B, the slits 31 are arranged in places invisible from the user on the front surface side of a display panel 21. Note that the display panel 21 is held by a front cabinet 22A.

In the sound collector 10 of this embodiment, for example, the voice of the user who is viewing a video reproduced on the display panel 21 is introduced from the slits 31 formed in the back cabinet 22B. The introduced voice propagates through the path 12 and is input to the microphone held by the microphone holding member 13. The voice of the user is converted into a voice signal by the microphone and sent to the voice processing module and the like included in the main body of the TV set 20.

The sound collector 10 according to this embodiment is tightly closed by the back cabinet 22B of the TV set 20 except the slits 31. It is therefore possible to cut off sounds (containing noise) from around the TV set 20 and effectively suppress the influence of echoes from the sound sources such as a loudspeaker 25 and a woofer 26. Hence, the sound collector 10 according to this embodiment can implement an effective sound collection function and stable voice input to the microphone.

### Ninth Embodiment

FIG. 13 is a view showing the arrangement of a sound collector 10 according to the ninth embodiment. Note that the peripheral arrangement of a TV set 20 is the same as that shown in FIGS. 11A and 11B, and a description thereof will be omitted.

As shown in FIG. 13, in this embodiment, two slits (opening portions) 31 are provided on the upper portion of a back cabinet 22B so as to be directed to the front surface side of a display panel 21. Note that the other arrangement is the same as that of the sound collector 10 according to the eight embodiment as shown in FIG. 12, and a description thereof will be omitted.

The sound collector 10 according to this embodiment is also tightly closed by the back cabinet 22B of the TV set 20 except the slits 31. It is therefore possible to cut off sounds (containing noise) from around the TV set 20 and effectively suppress the influence of echoes from the sound sources such as a loudspeaker 25 and a woofer 26. Hence, the sound collector 10 according to this embodiment can implement an effective sound collection function and stable voice input to the microphone. Especially, in this embodiment, since the slits 31 are directed to the front surface side of the display panel 21, for example, the voice of the user who is viewing a video reproduced on the display panel 21 can effectively be introduced.

As described above, the sound collector 10 according to each embodiment can be used as a kind of adapter detachable from the bezel or the back cabinet of the TV set 20. In a microphone built-in type TV set having the sound collection microphone incorporated in the bezel, the bezel and the display panel 21 are often integrated. Hence, the production process is complex, the production cost is expected to be relatively high. However, the sound collector 10 according to each embodiment enables to attach the microphone to a TV set without a built-in microphone. As a result, a TV set having a sound collection function can be provided at a relatively low production cost. That is, it is possible to implement an effective sound collection function and stable voice input to the microphone even in an electronic apparatus having only a limited space to arrange the microphone.

In the embodiments, the electronic apparatus to which the sound collector 10 is attached is assumed to be a TV set. However, the electronic apparatus is not limited to this, and the sound collector is also applicable to a personal computer or the like. The sound collector is also applicable to any other apparatus such as an air conditioner if it is operated by voice.

The various modules of the systems described herein can be implemented as software applications, hardware and/or software modules, or components on one or more computers, such as servers. While the various modules are illustrated separately, they may share some or all of the same underlying logic or code. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sound collector comprising:
a housing comprising an opening portion, wherein the opening portion is configured to receive a sound wave having a path, and wherein the housing is configured to be tightly closed except the opening portion; and
a microphone holding member in the housing and configured to hold a microphone configured to receive the sound wave propagating through the path at a predetermined position.

2. The sound collector of claim 1, wherein the microphone holding member is configured so as to arrange the microphone on the same plane as the path.

3. The sound collector of claim 1, wherein the housing is configured to set a distance from the opening portion to the microphone via the path based on a predetermined acoustic characteristic.

4. The sound collector of claim 1, wherein the microphone holding member is configured to have a predetermined angle with respect to the path so as to reflect the sound wave introduced from the opening portion and input the sound wave to the microphone.

5. The sound collector of claim 1, wherein the housing is configured to make the path continue in a horizontal direction and a vertical direction.

6. The sound collector of claim 1, wherein the housing is configured to reflect the path of the sound wave for input to the microphone.

7. The sound collector of claim 1, wherein
a plurality of housings are configured to be independently connected, and
a corresponding microphone is configured to input via a path a sound wave introduced from an opening portion of each of the housings.

8. An electronic apparatus comprising:
a sound collector comprising:
a housing comprising an opening portion, wherein the opening portion is configured to receive a sound wave having a path, and wherein the housing is configured to be tightly closed except the opening portion; and
a microphone holding member in the housing and configured to hold a microphone configured to receive the sound wave propagating through the path at a predetermined position,
a loudspeaker; and
a structure configured to attach the sound collector to a position having a predetermined distance from the loudspeaker.

9. An electronic apparatus comprising:
a sound collector comprising:
a housing comprising an opening portion,
wherein the opening portion is configured to receive a sound wave having a path, and wherein the housing is configured to be tightly closed except the opening portion; and
a microphone holding member in the housing and configured to hold a microphone configured to receive the sound wave propagating through the path at a first position,
a loudspeaker;
a bezel member configured to hold a display; and
a structure configured to attach the sound collector to a second position of the bezel having a predetermined distance from the loudspeaker.

10. The electronic apparatus of claim 8, wherein the sound collector is configured to direct the opening portion in a direction different from a sound source direction from the loudspeaker and a sound source generation unit.

11. An electronic apparatus comprising:
a main body comprising an opening portion, wherein the opening portion is configured to receive a sound wave; and
a sound collector configured to be detachably provided in the main body, wherein the main body is configured to be tightly closed except the opening portion,
wherein the sound collector comprises
a path of the sound wave received by the opening portion; and
a microphone holding member configured to hold a microphone configured to receive the sound wave propagating through the path at a predetermined position.

12. The electronic apparatus of claim 11, wherein the main body comprises
a first main body member configured to hold a display;
a second main body member on a side opposite to the first main body member; and
wherein the opening portion is provided at a part of the second main body member.
